(19) United States
(12) Patent Application Publication
(10) Pub. No.: US 2022/0200430 A1
(43) Pub. Date: Jun. 23, 2022

(54) LINEAR MOTOR

(71) Applicant: AAC Microtech (Changzhou) Co., Ltd., Changzhou City (CN)

(72) Inventors: Zhiyong Cui, Shenzhen (CN); Lubin Mao, Shenzhen (CN); Jie Ma, Shenzhen (CN); Kejia Liu, Shenzhen (CN); Ziang Li, Shenzhen (CN)

(21) Appl. No.: 17/553,703

(22) Filed: Dec. 16, 2021

(30) Foreign Application Priority Data
Dec. 17, 2020 (CN) 202023057818.7

(51) Int. Cl. H02K 33/10; H02K 1/17; H02K 41/02

(52) U.S. Cl. CPC H02K 33/10; H02K 41/02; H02K 1/17

(57) ABSTRACT

The present disclosure provides a linear motor including: a housing body with a containment space; a vibrator assembly suspended in the containment space by an elastic member for vibrating along a vibration direction; a stator assembly fixedly connected to the housing body and having a magnetic axis along the vibration direction; and two magnets located on both sides of the magnetic axis and spaced from the stator assembly, including a first magnet section and a second magnet section located on both sides of the first magnet section. A magnetic field strength of the first magnet section along the magnetic axis is greater than a magnetic field strength of the second magnet section along the magnetic axis. The configuration of the disclosure can effectively reduce the static attraction force of the magnetic circuit, and increase the overall rigidity of the linear motor.

### FIELD OF THE PRESENT DISCLOSURE

The present disclosure relates to electromagnetic motors, and more particularly to a linear motor for providing tactile feedback.

### DESCRIPTION OF RELATED ART

The magnetic circuit in the traditional linear motor (such as Super Linear Actuator, SLA) includes a solenoid with two magnets arranged at two ends of the solenoid. The magnets produce a larger attraction force to the solenoid, which makes the static attraction force of the entire magnetic circuit larger, thereby reducing the overall stiffness of the linear motor.

### SUMMARY OF THE PRESENT DISCLOSURE

One of the objects of the present disclosure is to provide a linear motor which can effectively reduce the static attraction force of the magnetic circuit, and increase the overall rigidity of the linear motor.

To achieve the above-mentioned objects, the present disclosure provides a linear motor comprising: a housing body with a containment space; a stator assembly fixedly connected to the housing body and having a magnetic axis along a vibration direction of the linear motor; a vibrator assembly suspended in the containment space by an elastic member for vibrating along the vibration direction; the vibrator assembly comprises: two magnets located on both sides of the magnetic axis along a direction perpendicular to the vibration direction and spaced from the stator assembly, each one of the two magnets including a first magnet section and a second magnet section located on both sides of the first magnet section along the vibration direction; wherein

A magnetic field strength of the first magnet section along the magnetic axis is greater than a magnetic field strength of the second magnet section along the magnetic axis.

In addition, the first magnet section comprises a first surface close to the stator assembly; the second magnet section comprises an inclined plane extending from one edge of the first surface along a direction gradually away from the magnetic axis.

In addition, the first magnet section further comprises a second surface away from the stator assembly; the first surface and the second surface are arranged opposite to each other along the direction perpendicular to the vibration direction; the second magnet section further comprises a third surface away from the inclined plane; the second surface is coplanar with the third surface.

In addition, the first magnet section is provided with a first surface and a second surface that are oppositely arranged along the direction perpendicular to the vibration direction; the second magnet section has a third surface and a fourth surface that are oppositely arranged along the direction perpendicular to the vibration direction; a distance between the first surface and the second surface along the direction perpendicular to the vibration direction is greater than a distance between the third surface and the fourth surface along the direction perpendicular to the vibration direction.

In addition, the first surface and the fourth surface are both close to the stator assembly; a distance between the first surfaces of the two magnets along the direction perpendicular to the vibration direction is smaller than a distance between the fourth surfaces of the two magnets along the direction perpendicular to the vibration direction.

In addition, the second surface is coplanar with the third surface.

In addition, the first surface and the fourth surface are both arranged close to the stator assembly and located in the same plane.

In addition, magnetization directions of the first magnet section and the second magnet section are opposite and both perpendicular to the vibration direction; magnetizing directions of the first magnet sections of the two magnets are opposite.

In addition, the vibrator assembly further comprises a weight having an accommodation space for accommodating the stator assembly and the two magnets; and the two magnets is attached to the weight through a yoke.

In addition, the stator assembly comprises a solenoid and a skeleton fixedly connected to the housing body; the solenoid is wound around the skeleton for forming the magnetic axis.

In addition, the linear motor further comprising a circuit board for providing electrical energy to the solenoid

In addition, the elastic member comprises an elastic arm, a first connection end and a second connection end that respectively bend and extend in the same direction from both ends of the elastic arm; the first connection end is connected to the weight; the second connection end is connected to the housing body; the elastic arm comprises a first bending part connected to the first connection end, a second bending part connected to the second connection end, and a body part connecting the first bending part and the second bending part.

In addition, the linear motor comprises two elastic members arranged opposite to the two ends of the weight along the vibration direction.

In addition, the weight spaces away from the accommodation space, and a protruding part is located on both sides of the magnetic axis; the housing body includes a baffle plate for buffering the impact of the protruding part.

In addition, the side of the first connection end away from the first bending part abuts against the protruding part.

In addition, the linear motor further comprises a damping member on the weight; wherein the damping member locates between the weight and the body part.

In addition, the linear motor further includes two engaging elements accommodated in the containment space; wherein the two engaging elements are arranged opposite to each other along the vibration direction and correspond to the two ends of the weight one by one; the weight includes an avoidance slot for avoiding the engaging element; and, the body part includes a groove for avoiding the engaging element.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an isometric and exploded view of a linear motor in accordance with an embodiment of the present disclosure;

FIG. 2 is an isometric and assembled view of the linear motor in FIG. 1;

FIG. 3 is a top view of the linear motor in FIG. 1 with an upper cover removed;

FIG. 4 is an isometric and exploded view of a linear motor in accordance with an embodiment of the present disclosure;

FIG. 5 is a top view of the linear motor shown in FIG. 4 with an upper cover removed;

FIG. 6 is a top view illustrating the position of a stator assembly and magnets of the linear motor in accordance with an embodiment of the present disclosure.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby is only to explain the disclosure, not intended to limit the disclosure.

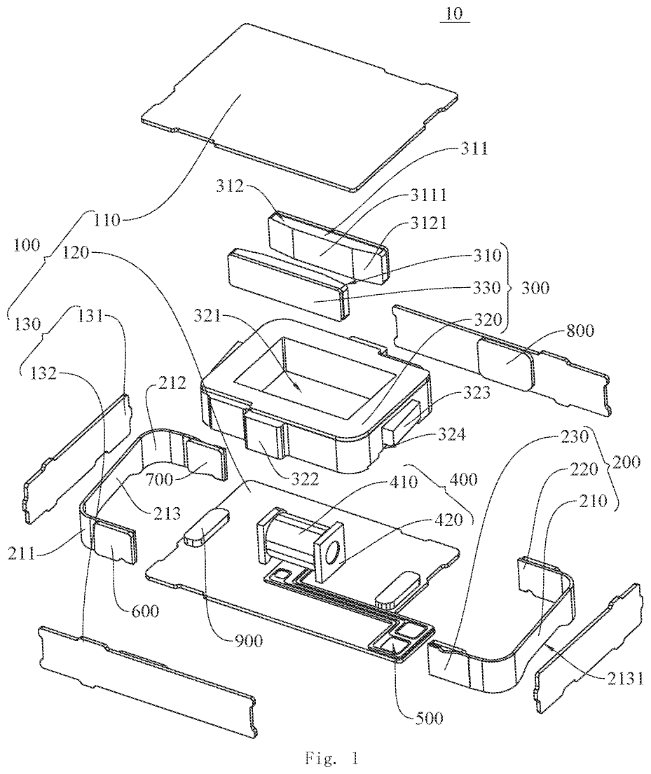

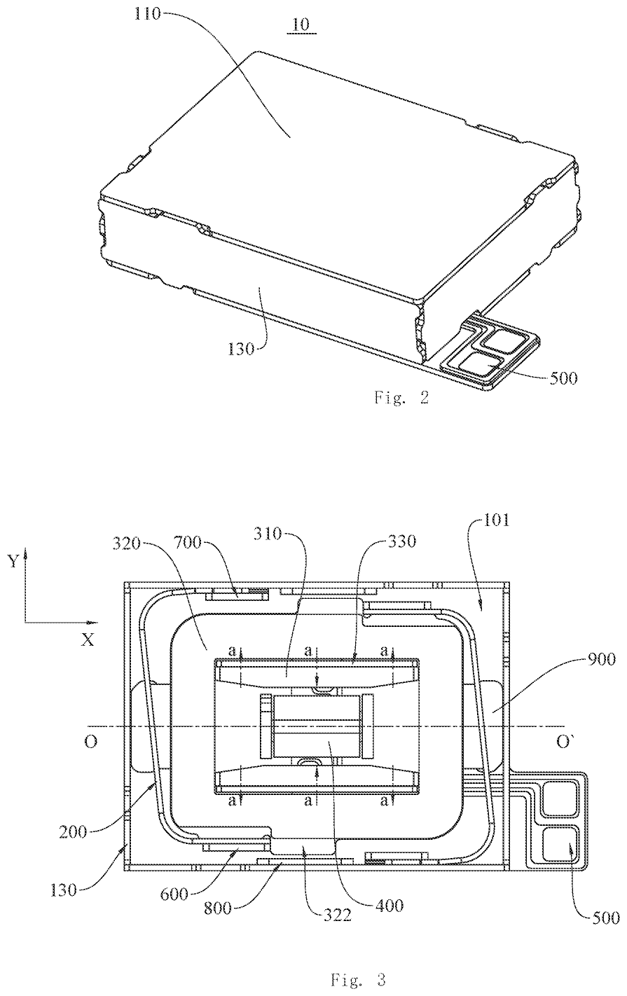

Please refer to FIGS. 1-6. The linear motor 10 provided by the present disclosure will now be described. The linear motor 10 comprises a housing body 100, an elastic member 200, a vibrator assembly 300, a stator assembly 400 and a circuit board 500. The housing body 100 is provided with a containment space 101. The vibrator assembly 300 is suspended in the containment space 101 through the elastic member 200. The vibrator assembly 300 can reciprocate in the vibration direction of the linear motor 10. The elastic member 200 can provide restoring force for the vibrator assembly 300. The stator assembly 400 is fixedly connected to the housing body 100. The stator assembly 400 is provided with a magnetic axis OO′ arranged along the vibration direction. The vibrator assembly 300 comprises two magnets 310 located on both sides of the magnetic axis OO′ along a direction perpendicular to the vibration direction and spaced apart from the stator assembly 400. Each one of the two magnets 310 comprises a first magnet section 311 and a second magnet section 312 located on both sides of the first magnet section 311. The magnetic field strength of the first magnet section 311 on the magnetic axis OO′ is greater than the magnetic field strength of the second magnet section 312 on the magnetic axis OO′. In this way, the second magnet section 312 produces a relatively small attraction force on the stator assembly 400, which can effectively reduce the static attraction force of the magnetic circuit formed by the magnet 310 and the stator assembly 400, thereby increasing the overall rigidity of the linear motor 10.

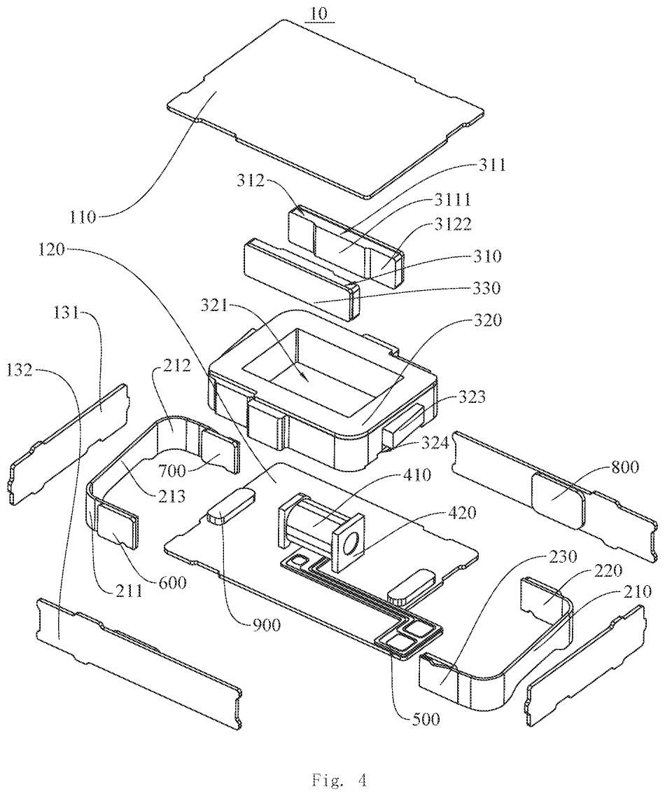

Please continue to refer to FIGS. 1-5, the housing body 100 comprises an upper cover 110 and a lower cover 120 arranged oppositely, and a circumferential sidewall 130 located between the upper cover 110 and the lower cover 120. The upper cover 110, the lower cover 120 and the circular sidewall 130 are enclosed to form the containment space 101. In this embodiment, the upper cover 110 and the circumferential sidewall 130 are connected by clamping connection. It can be understood that in other embodiments, the upper cover 110 and the circumferential sidewall 130 may also be connected as a whole by bonding or ultrasonic welding. Similarly, the circular sidewall 130 and the lower cover 120 can be connected as a whole by means of clamping, bonding or ultrasonic welding. As shown in FIG. 1 and FIG. 4, in this embodiment, the circumferential sidewall 130 comprises a first sidewall 131 arranged oppositely along the vibration direction, a second sidewall 132 located on both sides of the vibration direction. The adjacent first sidewall 131 and the second sidewall 132 can be connected as a whole by means of clamping, bonding or ultrasonic welding.

Please combine FIG. 1 and FIG. 3 together. In one embodiment, the first magnet section 311 has a first surface 3111 close to the stator assembly 400. The second magnet section 312 includes a inclined plane 3121 extending from one edge of the first surface 3111 along a direction gradually away from the magnetic axis OO′. In this way, a distance between the inclined planes 3121 of the two magnets 310 gradually increases from the first end to the second end. As a result, the intensity of the magnetic field formed by the second magnet section 312 at the position of the magnetic axis OO′ also gradually decreases along a direction away from the first magnet section 311, therefore, the magnet 310 can generate a small attraction force on the opposite ends of the stator assembly 400 along the vibration direction. In this way, the static attraction force of the magnetic circuit formed by magnet 310 and status assembly 400 is effectively reduced, thereby increasing the overall rigidity of linear motor 10

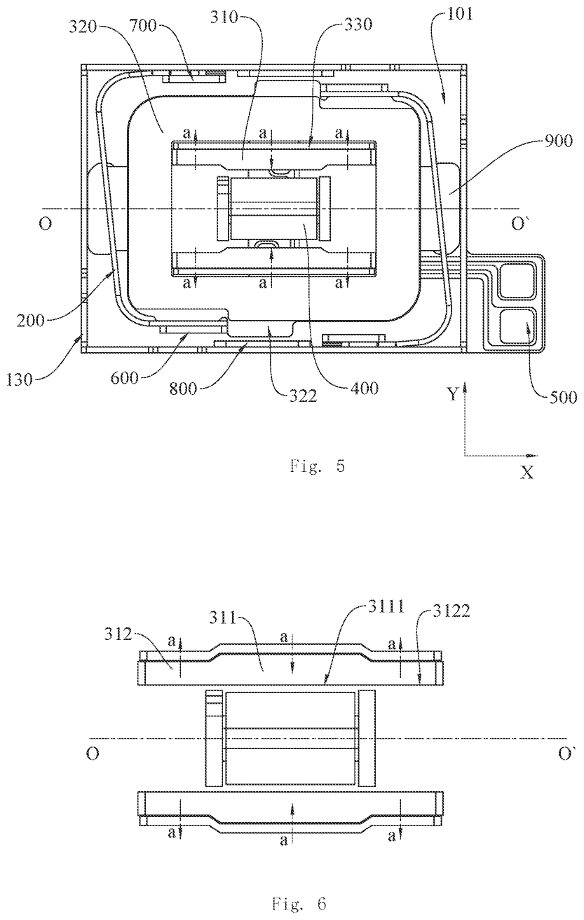

Further, the first magnet section 311 also has a second surface far away from the stator assembly 400. The first surface 3111 and the second surface are arranged opposite to each other along the vibration direction. The side of the second magnet section 312 away from the inclined plane 3121 also is provided with a third surface. The second surface and the third surface are in the same plane. This ensures that the thickness of the second magnet section 312 relative to the first magnet section 311 gradually decreases along the direction away from the first magnet section 311, and further ensures that the second magnet section 312 can generate a relatively small magnetic field intensity at the position of the magnetic axis OO′. The above arrangement makes the magnet 310 an isosceles trapezoid as a whole. The vibration direction is parallel to the direction indicated by the arrow X in FIGS. 3 and 5, and the direction perpendicular to the vibration direction is parallel to the direction indicated by the arrow Y in FIGS. 3 and 5.

Please refer to FIGS. 4 to 6 together. In one embodiment, the first magnet section 311 is provided with a first surface 3111 and a second surface that are arranged opposite to each other along the vibration direction. The second magnet section 312 is provided with a third surface and a fourth surface 3122 which are arranged opposite to each other along the vibration direction. The distance between the first surface 3111 and the second surface along the direction perpendicular to the vibration direction is greater than the distance between the third surface and the fourth surface 3122 along the direction perpendicular to the vibration direction. In this way, the second magnet section 312 has a smaller thickness than the first magnet section 311. Under the condition of integrated magnetization, the second magnet section 312 can generate a smaller magnetic field intensity at the position of the magnetic axis OO′.

Further, the first surface 3111 and the fourth surface 3122 are both arranged close to the stator assembly 400. The distance between the two opposed first surfaces 3111 is smaller than the distance between the two opposed fourth surfaces 3122. In this way, under the condition of ensuring that the second magnet section 312 has a smaller thickness relative to the first magnet section 311, the position of the second magnet section 312 relative to the magnetic core can be adjusted. That is, adjust the position of the fourth surface 3122 relative to the magnetic axis OO′, so as to adjust the magnetic field strength of the second magnet section 312 at the magnetic axis OO′. Furthermore, the second surface and the third surface are located in the same plane. As a result, the magnet 310 is in a symmetrical step shape as a whole.

As shown in FIG. 6, in another embodiment, the first surface 3111 and the fourth surface 3122 are both arranged close to the stator assembly 400 and located in the same plane. The thickness of the second magnet section 312 is smaller than that of the first magnet section 311. Therefore, the second magnet section 312 can also generate a relatively small magnetic field intensity at the position of the magnetic axis OO′. It can be understood that in other embodiments, under the condition that the thickness of the second magnet section 312 is less than the thickness of the first magnet section 311, the position of the second magnet section 312 relative to the magnetic axis OO′ can be adjusted along a direction perpendicular to the vibration direction. Thus, the intensity of the magnetic field generated by the second magnet section 312 at the position of the magnetic axis OO′ is adjusted.

On the basis of the foregoing embodiment, the magnetization directions a of the first magnet section 311 and the second magnet section 312 are both perpendicular to the vibration direction and opposite in direction. The magnet 310 is a three-polar magnet with integrated magnetization. The magnetization directions a of the two opposed first magnet sections 311 are opposite. In this way, the symmetry of the magnetic field formed by the two magnets 310 is ensured.

In one embodiment, the vibrator assembly 300 further comprises a weight 320. The weight 320 is provided with an accommodation space 321. Both the stator assembly 400 and the magnet 310 are accommodated in the accommodation space 321. The magnet 310 is connected to the weight 320 through the yoke 330. The yoke 330 and the magnet 310 are connected to the side away from the stator assembly 400 to fix the magnet 310 on the weight 320.

In one embodiment, the stator assembly 400 comprises a solenoid 410 and a skeleton 420 fixedly connected to the housing body 100. The solenoid 410 is wound on the skeleton 420 to form a magnetic axis OO′. In this embodiment, the circuit board 500 is used to deliver electrical energy to the solenoid 410 so that the solenoid 410 can generate a magnetic field. Specifically, the circuit board 500 is attached to the side of the lower cover 120 close to the circular sidewall 130 and passes through the circular sidewall 130 to be electrically connected to the solenoid 410, so that the solenoid 410 is energized and generates a magnetic field. The magnetic field generated by the solenoid 410 interacts with the magnetic field generated by the magnet 310 to drive the vibrator assembly 300 to reciprocate in the vibration direction in the containment space 101.

In one embodiment, the number of elastic members 200 is two, and the two elastic members 200 are arranged opposite to the two ends of the weight 320 along the vibration direction. In this way, the elastic member 200 is provided at both ends of the weight 320 to ensure the stability of the vibration of the vibrator assembly 300. Specifically, the elastic member 200 comprises an elastic arm 210 and a first connection end 220 and a second connection end 230 that respectively bend and extend in the same direction from both ends of the elastic arm 210. The first connection end 220 is connected to the weight 320, and the second connection end 230 is connected to the housing body 100. The elastic arm 210 comprises a first bending part 211 connected to the first connection end 220, a second bending part 212 connected to the second connection end 230, and a body part 213 connecting the first bending part 211 and the second bending part 212. The first connection end 220 is clamped on the weight 320 by the first fastener 600. The second connection end 230 is clamped on the circumferential sidewall 130 by the second fastener 700.

In one embodiment, the weight 320 is far away from the accommodation space 321, and protruding parts 322 are provided on both sides of the magnetic axis OO′. The housing body 100 is provided with a baffle plate 800 for buffering the impact of the protruding part 322. In this way, the baffle plate 800 can prevent the protruding part 322 from impacting the housing body 100. On the other hand, the protruding part 322 and the baffle plate 800 can also cooperate with the guidance to prevent the vibrator assembly 300 vibrating in a direction deviating from the vibration direction.

In one embodiment, the first connection end 220 abuts on the protruding part 322 on the side away from the first bending part 211. In this way, the connection strength between the first connection end 220 and the weight 320 can be further ensured, and the stability of the connection can be ensured.

In an embodiment, a damping member 323 is further provided on the weight 320, and the damping member 323 is provided between the weight 320 and the body part 213. The damping member 323 can provide the damping required for the vibrator assembly 300 to work in the vibration direction, and can be compressed and fitted with the elastic member 200. The stability of the damping generated by the compression of the damping member 323 is ensured, thereby ensuring the stability of the vibration of the vibrator assembly 300.

In one embodiment, two engaging elements 900 are also accommodated in the containment space 101. The two engaging elements 900 are arranged opposite to each other along the vibration direction and correspond to the two ends of the weight 320 one by one. An avoidance slot 324 of the avoidance member 900 is provided on the weight 320. A groove 2131 of the avoidance member 900 is provided on the body part 213 The engaging element900 and avoidance slot 324 are set at intervals. During the vibration process, the engaging element 900 is partially accommodated in the avoidance slot 324 to block the weight 320 and effectively avoid the performance degradation caused by the excessive deformation of the elastic member 200. At the same time, a groove 2131 is arranged on the body part 213, and the groove 2131 is used for the avoidance member 900.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms where the appended claims are expressed.

What is claimed is:

1. A linear motor comprising:
a housing body with a containment space;
a stator assembly fixedly connected to the housing body and having a magnetic axis along a vibration direction of the linear motor;
a vibrator assembly suspended in the containment space by an elastic member for vibrating along the vibration direction; the vibrator assembly comprises:
two magnets located on both sides of the magnetic axis along a direction perpendicular to the vibration direction and spaced from the stator assembly, each one of the two magnets including a first magnet section and a second magnet section located on both sides of the first magnet section along the vibration direction; wherein
a magnetic field strength of the first magnet section along the magnetic axis is greater than a magnetic field strength of the second magnet section along the magnetic axis.

2. The linear motor as described in claim 1, wherein the first magnet section comprises a first surface close to the stator assembly; the second magnet section comprises an inclined plane extending from one edge of the first surface along a direction gradually away from the magnetic axis.

3. The linear motor as described in claim 2, wherein the first magnet section further comprises a second surface away from the stator assembly; the first surface and the second surface are arranged opposite to each other along the direction perpendicular to the vibration direction; the second magnet section further comprises a third surface away from the inclined plane; the second surface is coplanar with the third surface.

4. The linear motor as described in claim 1, wherein the first magnet section is provided with a first surface and a second surface that are oppositely arranged along the direction perpendicular to the vibration direction; the second magnet section has a third surface and a fourth surface that are oppositely arranged along the direction perpendicular to the vibration direction; a distance between the first surface and the second surface along the direction perpendicular to the vibration direction is greater than a distance between the third surface and the fourth surface along the direction perpendicular to the vibration direction.

5. The linear motor as described in claim 4, wherein the first surface and the fourth surface are both close to the stator assembly; a distance between the first surfaces of the two magnets along the direction perpendicular to the vibration direction is smaller than a distance between the fourth surfaces of the two magnets along the direction perpendicular to the vibration direction.

6. The linear motor as described in claim 5, wherein the second surface is coplanar with the third surface.

7. The linear motor as described in claim 4, wherein the first surface and the fourth surface are both arranged close to the stator assembly and located in the same plane.

8. The linear motor as described in claim 1, wherein magnetization directions of the first magnet section and the second magnet section are opposite and both perpendicular to the vibration direction; magnetizing directions of the first magnet sections of the two magnets are opposite.

9. The linear motor as described in claim 8, wherein the vibrator assembly further comprises a weight having an accommodation space for accommodating the stator assembly and the two magnets; and the two magnets is attached to the weight through a yoke.

10. The linear motor as described in claim 9, wherein the stator assembly comprises a solenoid and a skeleton fixedly connected to the housing body; the solenoid is wound around the skeleton for forming the magnetic axis.

11. The linear motor as described in claim 10 further comprising a circuit board for providing electrical energy to the solenoid.

12. The linear motor as described in claim 10, wherein the elastic member comprises an elastic arm, a first connection end and a second connection end that respectively bend and extend in the same direction from both ends of the elastic arm; the first connection end is connected to the weight; the second connection end is connected to the housing body; the elastic arm comprises a first bending part connected to the first connection end, a second bending part connected to the second connection end, and a body part connecting the first bending part and the second bending part.

13. The linear motor as described in claim 12 comprising two elastic members arranged opposite to the two ends of the weight along the vibration direction.

14. The linear motor as described in claim 13, wherein, the weight spaces away from the accommodation space, and a protruding part is located on both sides of the magnetic axis; the housing body includes a baffle plate for buffering the impact of the protruding part.

15. The linear motor as described in claim 14, wherein, the side of the first connection end away from the first bending part abuts against the protruding part.

16. The linear motor as described in claim 14 further comprising a damping member on the weight; wherein the damping member locates between the weight and the body part.

17. The linear motor as described in claim 14 further including two engaging elements accommodated in the containment space; wherein the two engaging elements are arranged opposite to each other along the vibration direction and correspond to the two ends of the weight one by one; the weight includes an avoidance slot for avoiding the engaging element; and, the body part includes a groove for avoiding the engaging element.
